(19) United States
(12) Patent Application Publication
(10) Pub. No.: US 2009/0053320 A1
(43) Pub. Date: Feb. 26, 2009

(54) Disease and Pest Control Agent Containing Dissolved Microbubles Consisting of Oxygen and Ozone

(76) Inventor: Tong-Rae Cho, Daejeon City (KR)

Correspondence Address: WENDEROTH, LIND & PONACK, L.L.P., 2033 K STREET N. W., SUITE 800, WASHINGTON, DC, 20006-1021, US

(21) Appl. No.: 11/988,098

(22) PCT Filed: Jul. 4, 2006
(86) PCT No.: PCT/KR2006/002604

§ 371 Date: Dec. 31, 2007

(30) Foreign Application Priority Data
Jul. 8, 2005 (KR) 10-2005-0061759

(51) Int. Cl. A01N 59/00

(52) U.S. Cl. 424/613

(57) ABSTRACT

The present invention relates to systems and methods for producing disease and pest control agent for plants and crops containing dissolved oxygen and ozone. This present invention of disease and pest control agent for plants and crops containing dissolved microbubbles of oxygen and ozone consists of 0.3-40 μm pore size microbubbles of ozone (03) 1.0-10.0 volume % and oxygen (O2) 99.0-90.0 volume % dissolved in water as colloids and the concentration of ozone in this solution is 1˜30 mg/l. This invention produces disease and pest control agent for plants and crops that contains microbubbles consisting of highly concentrated oxygen and ozone dissolved in water as colloid which is environmentally friendly and highly effective as pesticidal and germicidal agent.

### SUMMARY EXPLANATION OF DIAGRAM

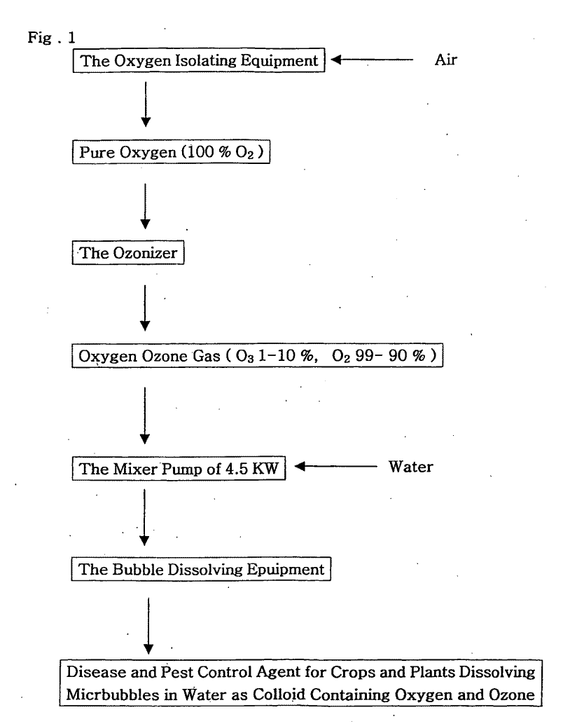

FIG. 1 shows the preparation process of this invention of disease and pest control agent containing dissolved microbubbles consisting of oxygen and ozone.

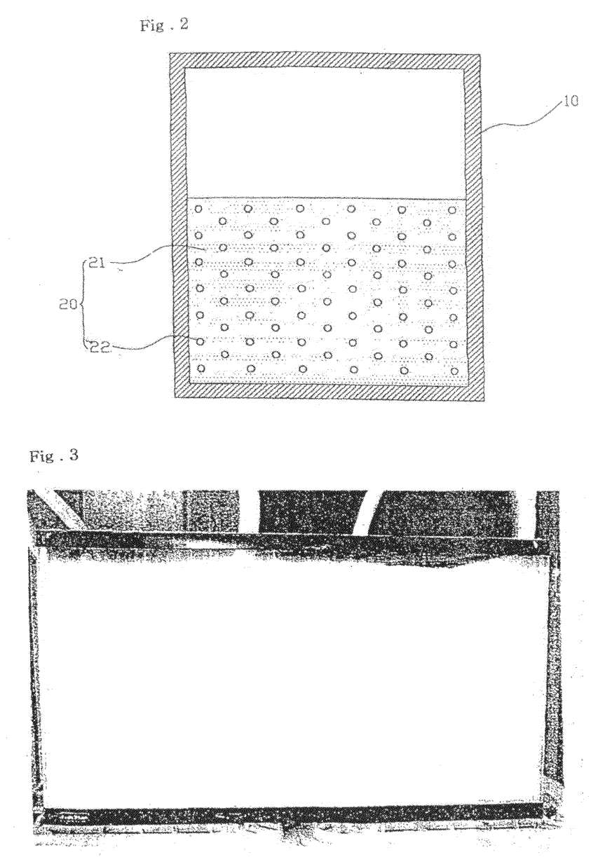

FIG. 2 shows the status diagram of this invention of disease and pest control agent containing dissolved microbubbles consisting of oxygen and ozone.

10: Container
20: disease and pest control agent
21: water
22: microbubbles

FIG. 3 shows a photograph of this invention of disease and pest control agent containing dissolved microbubbles consisting of oxygen and ozone.

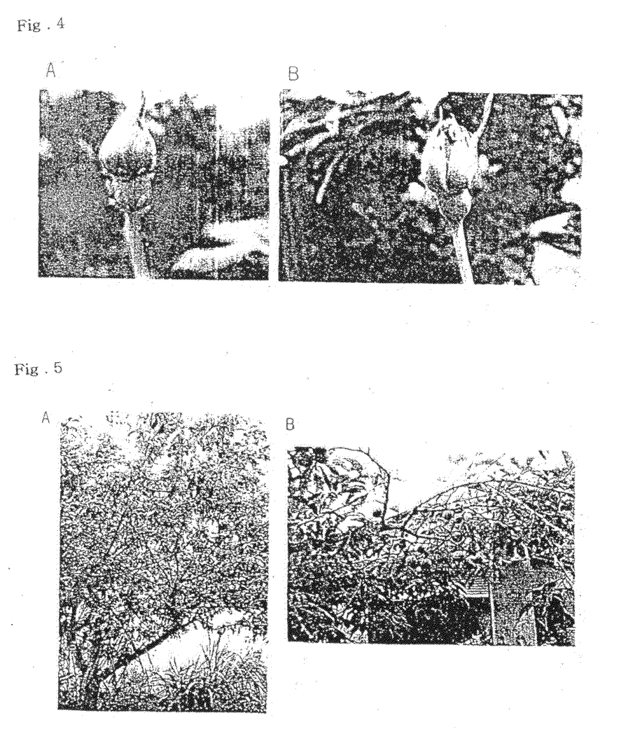

FIG. 4 shows a photograph of extinguishing aphids on roses using this invention of disease and pest control agent containing dissolved microbubbles consisting of oxygen and ozone.

A: Photograph of roses before treatment with disease and pest control agent

B: Photograph of roses 4 (four) days after treatment with disease and pest control agent

FIG. 5 shows photograph of plums treated with this invention of disease and pest control agent containing dissolved microbubbles consisting of oxygen and ozone.

A: Photograph of untreated plums

B: Photograph of plums treated with disease and pest control agent

### DETAILED EXPLANATION OF THE INVENTION

### Purpose of the Invention

### Technical Area of this Invention and the Prior Art in this Area

This invention relates to crops and pest control agent containing dissolved microbubbles consisting of oxygen and ozone.

Recently, there have been many attempts to develop environmentally friendly pesticide and germicide that does not pollute the environment and is not harmful the human body.

Meanwhile, Ozone (O3) is an allotrope of oxygen which is pale blue colour at room temperature, which has a particular odour and has a special characteristic that it is difficult to dissolve in water.

Ozone is produced by heating oxygen, electrolysis of sulphuric acid and transition in the air of ultraviolet rays, x-rays, cathode rays and is present in the atmosphere that is abundant in ultraviolet rays in high mountains, the seashore and in the forests and gives a sense of refreshment, but when there is too much of it, it rather produces an unpleasant effect. Ordinarily, ozone is used for cleaning the air, and its germicidal effect is used for disinfecting drinking water and bleaching.

There has been attempts to use ozone, with its special germicidal character, dissolved in water on crops instead of chemical pesticide.

To dissolve ozone in water to use on crops, first a large quantity of ozone must be produced. The existing methods of producing ozone are electric discharge of oxygen, irradiation of ultraviolet rays, electro lysis of water, and so on.

The electric discharge method converts oxygen into ozone using electric discharge tube, and the quantity of ozone produced from one tube is very small. To produce a large quantity of ozone, a large number of electric discharge tube must be used, which increases the size of the ozonizer making it difficult to transport and to use, and results in increased expenses.

The ultraviolet irradiation method produces ozone by putting oxygen through light bulb that produces ultraviolet rays, and the quantity of ozone that can be produced by one bulb is very small and to produce a large quantity of ozone, a large quantity of ultraviolet ray bulbs are required. Therefore, to make a high concentration of ozone solution, the ozonizer becomes larger and bulky making it difficult to use and to transport and is more expensive.

The electrolysis of water method produces ozone by converting into ozone the oxygen that results from electrolysis of water, but this method also produces only a small quantity of ozone and has the same problems as the other methods described above of being very expensive and difficult to use.

To use ozone dissolved in water for crops and such, the existing methods pass ozone through water as ozone gas bubbles to produce ozone solution.

Here, the quantity of ozone that dissolves in water is determined by how long water and ozone are in contact with each other, and the bigger the size of ozone bubbles the quicker they rise in water to the surface resulting in shorter contact time with water and smaller quantity of ozone is dissolved in water.

To dissolve a large quantity of ozone in water, it is necessary to make the size of the ozone bubbles smaller and to keep ozone in water for a longer duration but presently, there is no suitable method to decrease the size of the ozone bubbles.

Furthermore, passing smaller ozone bubbles in water for a longer period increases the concentration of ozone for a short while, but as time passes ozone breaks down in water and after 30 minutes, the ozone concentration level is halved and it is not possible to maintain continuously the initial ozone concentration level using the existing methods.

Korean registered patent 10-2003-0045419 (Sterilization equipment for crops using ozone and TiO2 photocatalyst) shows crop sterilization equipment using ozone and TiO2 photocatalyst to remove bacteria and pesticide residue on crops and plants.

Korean registered patent 10-1998-004694 (environmentally friendly farming method and equipment using cathion and ozone (O3)) shows an invention related to environmentally friendly farming method using cathion and ozone (O3) production equipment to dissolve in water cathion and ozone produced in the atmosphere and using this to eliminate bacteria, and to spray on crops and soil the oxygen rich cathion solution and ozone solution.

However, the methods described above using existing ozonizer to dissolve ozone in water dissolves only a very small quantity of ozone in water due to the particular characteristic of ozone which does not dissolve easily in water and therefore it is not sufficient to use the ozone solution on crops instead of traditional pesticides to prevent and eliminate pests and disease in crops.

In addition, as described above, the existing technology does not solve the problem of ozone breaking down in water thereby decreasing the concentration of ozone making it difficult to maintain the ozone concentration level.

Therefore, using the existing technology, it is not possible to produce a highly concentrated ozone solution and to maintain such concentration level for continuous supply making it difficult for practical application on crops and plants.

### The Technological Aim of the Invention

The present invention aims to solve the problems described above by providing a disease and pest control agent which contains high concentration levels of microbubbles consisting of oxygen and ozone dissolved in water as colloids that is environmentally friendly and yet highly effective as pesticide and germicide.

Furthermore, the present invention aims to provide a method to treat crops with a solution, which contains microbubbles consisting of oxygen and ozone dissolved in water in colloid state, that maintains its initial concentration level at production.

### Description of Invention

The present invention relates to disease and pest control agent for plants and crops containing dissolved microbubbles consisting of oxygen and ozone.

The present invention of disease and pest control agent for plants and crops containing dissolved microbubbles of oxygen and ozone consists of 0.3-40 μm pore size microbubbles of ozone (O3) 1.0-10.0 volume % and oxygen (O2) 99.0-90.0 volume % dissolved in water as colloids and the concentration of ozone in this solution is 1˜30 mg/l.

To explain more precisely, the present invention of disease and pest control agent uses oxygen separation equipment to separate and pure oxygen (99.0-99.99% O2) in the atmosphere, and inputs the isolated oxygen into the ozonizer to make oxygen ozone gas consisting of ozone (O3) 1.0-10.0 volume % and oxygen (O2) 99.0-90.0 volume%, and using a 4.5 KW mixer pump to input and mix together the above described oxygen ozone gas at the speed of 0.5-21 l/min

and water at the speed of 300-700 l/min, and to move the mixed solution from mixer pump to bubble dissolving equipment, then to rotate the mixed solution for 10 minutes resulting in 0.3˜40 μm diameter bubbles dissolved in water in colloid state, with the ozone concentration level in this solution of 1˜30 mg/l, producing a disease and pest control agent for crops and plants.

Furthermore, the method of spraying the present invention of disease and pest control agent sprays the present invention of disease and pest control agent containing dissolved microbubbles consisting of oxygen and ozone 0.3˜3 m3/h within 1 (one) minute and at the same time, controls the input flow speed of oxygen ozone gas

and the water into the mixer pump to maintain the same concentration as the used solution and also maintains the same level of ozone concentration by continuously supplying the same amount of solution, as the amount of solution used through the mixer pump, into the bubble dissolving equipment at 0.3˜3 m3/h.

There are hundreds of types of diseases occurring in crops and plants, and especially among these the same or similar bacteria can cause disease in many different plants and crops.

Thus, the significant diseases are botrytis blight, downy mildew, powdery mildew, anthrax, wilt, leafage disease, leaf mold disease, gray mold, plague, wart, bacillus carotovorus, cucurbit wilt, spot disease by bacteria, mosaic disease, but even with different types of fruit and vegetables, the bacteria causing the disease are similar and therefore it is possible to find out disease and the preventative method is also similar

Therefore, ordinarily one must find out what type of disease is caused before using pesticide, but for example, the usual germicide/bactericide agents are mostly ineffective against fungal diseases, but on the other hand, fungicidal agents are mostly ineffective against bacterial diseases, and if the disease is diagnosed incorrectly and the wrong germicide is used, then this only results in an expensive waste of germicide.

Also, recently, there has been a heightened interest in the environment and health and a lot of efforts and research have been conducted in developing environmentally friendly disease and pest control agent.

On the other hand, ozone (O3) is a gas that does not dissolve easily in water and is generally used for purifying air, and its bactericidal capability is used to sterilize water and as bleaching agent.

Lately there has been attempts to use the bactericidal capability of ozone to treat crops and plants, but because of ozone's insoluble characteristic in water, the commonly used equipment such as water air disperser in water or pressurized pump results in only a weak solution containing a very small amount of ozone of 0.02 μm/l concentration of ozone in 10 minutes of dissolution,

To use ozone dissolved in water to treat crops, ordinarily ozone is input through water as bubbles to dissolve ozone in water.

Here, the quantity of ozone that dissolves in water is determined by the length of time during which water and ozone are in contact with each other, but the bigger the size of the bubbles, the faster they rise to the surface of water and the shorter the contact time between ozone and water and only a small amount of ozone dissolves in water.

To dissolve a large quantity of ozone in water, for the same concentration level of ,ozone, it is necessary to make the size of the ozone bubbles smaller and to keep ozone in water for a longer duration but until the present, there has not been a suitable method to decrease the size of the ozone bubbles smaller.

Furthermore, inputting smaller ozone bubbles in water for a longer period increases the concentration of ozone for an instance, but as time passes ozone decompose in water and after 30 minutes, the ozone concentration level is halved and it is not possible to maintain continuously the initial ozone concentration level using the existing methods.

Therefore, the present inventor wished to solve the problems described above to develop a disease and pest control agent for crops that contains a higher concentration of ozone and has a large preventative effect against diseases, and through research and numerous trial and error, accomplished the present invention.

To solve the problem of insolubility of ozone in water, the applicant of the present invention used a previously registered invention of the present applicant, the registered patent 10-0465756 (apparatus for microbubbles dissolution).

The above bubble dissolution apparatus can take large bubbles that have a large diameter and together with the water produce whirlflow through the whirlflow generator inside the circulatory tube and during this process break down the bubbles through the bubble pulverizer to produce microbubbles that are so minute that they rise only 1 metre in one hour to the surface of water, thereby increasing the contact time with the water and produce rapidly a high degree of contact oxidization effect and dissolution effect.

The present invention uses the above described apparatus for bubbles dissolution to make minute bubbles with diameter of 0.3˜40 μm and thus produce solution that contains a highly concentrated ozone in colloid state.

The present invention uses oxygen separation apparatus to (PSA, Presser Swing Adsorption ) to separate pure oxygen (99.0˜99.99% O₂) from the atmosphere, and input the separated pure oxygen in the ozonizer to make oxygen ozone gas consisting of ozone (O₃) 1.0˜10.0 volume % and oxygen (O₂) 99.0˜90.0 volume%, then using a 4.5 KW mixer pump, pump the above oxygen ozone gas at the speed of 0.5-21 l/min

and water at the speed of 300˜700 l/min to mix together, and to move this mixed solution from the mixer pump to the bubble dissolving apparatus and circulate for 10 minutes to produce a crop disease and pest control agent that contains microbubbles with diameter of 0.3˜40 μm dissolved in water as colloids, and the concentration of ozone in this solution is 1˜30 mg/l.

At this time, the present invention uses an oxygen separating apparatus using the absorbent ZMS and the differential absorption quantity in the equilibrium state so absorb nitrogen (N₂) and to isolate oxygen (O₂) from the atmosphere that contains 78.08% nitrogen and 20.95% oxygen.

Also, the ozonizer; used to produce ozone uses the principle of the electron breaking the ring of an oxygen molecule to produce two unstable oxygen atoms which then react with an oxygen molecule to create ozone.

Furthermore, the present invention uses 4.5 KW mixer pump to mix the oxygen ozone gas produced by the ozonizer with water and then to transport it to the bubble dissolving apparatus.

Here, the mixer pump is used to mix the oxygen ozone gas input at the speed of 0.5˜21 l/min and water input at the speed of 300˜700 l/min into the mixer pump, and then at the same speed as the input speed, transport the mixture to the bubble dissolving apparatus to make the ozone concentration at 1˜30 mg/l.

In particular, if the oxygen ozone gas produced by the ozonizer consists of ozone (O₃) 1.0˜4.0 volume % and oxygen (O₂) 99.0˜96.0 volume %, then it is advisable to input the water into the mixer pump at the speed of 300˜400 l/min, and if the oxygen ozone gas consists of ozone (O₃) 4.1˜10.0 volume % and oxygen (O₂) 90.0˜95.9 volume %, then it is advisable to input the water into the mixer pump at the speed of 400˜700 l/min.

Using the disease and pest control agent for crops and plants in the present invention produced as described above, through numerous experiments and research, it was possible to find out the most effective concentration level of the colloid solution.

For rice, barley, wheat, beans, potato and such foodstuff; tomato, cucumber, watermelon, melon, honeydew melon, eggplant, zucchini, pumpkin and such fruit and vegetables; ginseng, codonopsis, paeonia, milk vetch, gastrodia, and such herbs; rose, tulip, lily and such flowers; and apple, pear, mandarin, chestnut, dates, peach, Japanese apricot, plum,

and such fruits, spraying them with a solution with less than 1 mg/l concentration level of ozone had little or no disease or pest control effect, and spraying a solution with an ozone concentration level of between 1˜30 mg/l had an excellent disease and pest control effect, and spraying a solution with an ozone concentration level of greater than 30 mg/l produced a result of the leaves drying up.

Therefore, to use the disease and pest control agent of the present invention to prevent disease and pest in the foodstuff, vegetables, herbs and fruits, the most suitable method is to spray a solution with the ozone concentration level of 1˜30 mg/l to obtain the best preventative effect.

Also, to control disease and pest in chilli, lettuce, iceberg lettuce, spinach, shallots, Korean leek, Chinese cabbage, sesame, wild sesame and such vegetables, spraying the vegetables with a solution with less than 1 mg/l concentration level of ozone had little or no disease or pest control effect, and spraying a solution with an ozone concentration level of between 1˜20 mg/l had an excellent disease and pest control effect, and spraying, a solution with an ozone concentration level of greater than 20 mg/l produced a result of the leaves drying up.

Therefore, it was possible to find out that to use the disease and pest control agent of the present invention to prevent disease and pest in such vegetables [described above in <60>], the most suitable method is to spray them with a solution that has the ozone concentration level of 1˜20 mg/l to obtain the best preventative effect.

The following is a detailed explanation of the present invention of disease and pest control agent containing dissolved microbubbles consisting of oxygen and ozone.

The manufacturing process for the present invention of disease and pest control agent containing dissolved microbubbles consisting of oxygen and ozone

1. Pure oxygen (100% O₂) separation

Using an oxygen separation apparatus (Pressure Swing Adsorption, PSA), isolate pure oxygen (99.0˜99.99% O₂) from the air.

2. Produce oxygen ozone gas

Prepare ozone production apparatus.

Input the above separated pure oxygen (99.0˜99.99% O₂) into the ozone production apparatus to create oxygen ozone gas consisting of ozone (O₃) 1.0˜10.0 volume % and oxygen (O₂) 99.0˜90.0 volume %,

3. Manufacture the mixed solution

Prepare the 4.5 KW mixer pump.

Into this mixer pump, input the above oxygen ozone gas at the speed of 0.5˜21 l/min and water at the speed of 300˜700 l/min into the mixer pump to mix together.

At this time, if the oxygen ozone gas produced by the ozonizer consists of ozone (O₃) 1.0˜4.0 volume % and oxygen (O₂) 99.0˜96.0 volume %, then it is advisable to input the water into the mixer pump at the speed of 300˜400 l/min, and if the oxygen ozone gas consists of ozone (O₃) 4.1˜10.0 volume % and oxygen (O₂) 90.0˜95.9 volume %, then it is advisable to input the water into the mixer pump at the speed of 400˜700 l/min.

4. Manufacture of disease and pest control agent in the colloid state

Prepare the present invention applicant's previously submitted and published registered patent 10-0465756 the microbubble dissolving apparatus.

Using the mixer pump, input the mixed solution into the prepared bubble dissolving apparatus and circulate for 10 minutes to produce a solution in the colloid state which contains microbubbles consisting of ozone (O₃) 1.0˜10.0 volume % and oxygen (O₂) 99.0˜90.0 volume % dissolved in water.

Also, here the ozone concentration level of this solution, that is the disease and pest control agent, is 1˜30 mg/l and the microbubbles are dissolved in colloid state thus giving it milky appearance.

It is possible to prevent the damages to crops by disease and pests using the colloid state solution containing microbubbles consisting of oxygen and ozone dissolved in water of the present invention manufactured as described in the above manufacturing process.

When spraying on crops with the disease and pest control agent of the present invention, it should be sprayed at the rate of 0.3˜3 m³/h within 1 minute and at the same time as spraying, input the ozone oxygen gas and the water at the speed which produces the same concentration level, and through the mixer pump continuously input the same quantity of solution as the amount used into the microbubble dissolving apparatus at the rate of 0.3-3 m³/h to maintain the same level of ozone concentration level.

On the other hand, when spraying the disease and pest control agent of this invention on fruits, it is the most effective to use a solution that has the ozone concentration level of 1˜30 mg/l, and when spraying vegetables, it is the most effective to use a solution that has the ozone concentration level of 1˜20 mg/l.

Bellow, some practical examples and experimental applications of the present invention are explained in further detail, but they do not limit the scope of the present invention.

### PRACTICAL EXAMPLE 1

Manufacture 1 of the present invention disease and pest control agent for crops and plants containing dissolved microbubbles consisting of oxygen and ozone

The oxygen separating apparatus (Pressure Swing Adsorption) is prepared.

Using this oxygen separating apparatus, pure oxygen (100% O₂) is separated from the atmosphere.

The ozonizer is prepared.

The pure oxygen (100% O₂) separated as above is input in the prepared ozone to make oxygen ozone gas consisting of ozone (O₃) 2.3 volume % and oxygen (O₂) 97.7 volume %.

A mixer pump of 4.5 KW is prepared.

In this mixer pump, the above oxygen ozone gas is input at the speed of 0.5 l/min and water is input at the speed of 300 l/min and mixed together.

The present invention's applicant's previously submitted registered patent 10-0465756 bubble dissolving apparatus is prepared.

Using the mixer pump, the mixed solution is input into the prepared bubble dissolving apparatus and circulated for 10 minutes to produce colloid state solution that contains microbubbles with a diameter of 0.5 μm consisting of ozone (O₃) 2.3 volume % and oxygen (O₂) 97.7 volume %.

The ozone concentration level is measured using the system in type of ozone monitor (type EG/EL-550Evala Co), and a solution of a disease and pest control agent for crops of the present invention which has an ozone concentration level of 1 mg/l containing microubbles consisting of oxygen and ozone dissolved in water in colloid state.

### PRACTICAL EXAMPLE 2

Manufacture 2 of the present invention disease and pest control agent for crops and plants containing dissolved microbubbles consisting of oxygen and ozone

The oxygen separating apparatus (Pressure Swing Adsorption) is prepared.

Using this oxygen separating apparatus, pure oxygen (100% O₂) is separated from the atmosphere.

The ozonizer is prepared.

The pure oxygen (100% O₂) separated as above is input in the prepared ozonizer to make oxygen ozone gas consisting of ozone (O₃) 7.5 volume % and oxygen (O₂) 92.5 volume%.

A mixer pump of 4.5 KW is prepared.

In this mixer pump, the above oxygen ozone gas is input at the speed of 0.5 l/min and water is input at the speed of 600 l/min and mixed together.

The present invention's applicant's previously submitted registered patent 10-0465756 bubble dissolving apparatus is prepared

Using the mixer pump, the mixed solution is input into the prepared bubble dissolving apparatus and circulated for 10 minutes to produce a colloid state solution that contains microbubbles with a diameter of 10.0 μm consisting of ozone (O₃) 7.5 volume % and oxygen (O₂) 92.5 volume %.

The ozone concentration level is measured using the system in type of ozone moniter (type EG/EL-550Evala Co), and a solution of a disease and pest control agent for crops of the present invention which has an ozone concentration level of 10 mg/l containing microubbles consisting of oxygen and ozone dissolved in water in colloid state.

### PRACTICAL EXAMPLE 3

Manufacture 3 of the present invention disease and pest control agent for crops and plants containing dissolved microbubbles consisting of oxygen and ozone

The solution is prepared using the same method as the disease and pest control agent of the present invention given in practical example 1 described above, however the oxygen ozone gas is input at the speed of 13 l/min and the water is input at the speed of 300 l/min into mixer pump then moved to the bubble dissolving apparatus and circulated for 10 minutes to produce a colloid state solution that contains microbubbles with a diameter of 25.0 μm consisting of ozone (O₃) 2.3 volume % and oxygen (O₂) 97.7 volume %.

The ozone concentration level is measured using the system in type of ozone monitor (type EG/EL-55OEvala Co), and a solution of a disease and pest control agent for crops of the present invention which has an ozone concentration level of 20 mg/l containing microubbles consisting of oxygen and ozone dissolved in water in colloid state.

### PRACTICAL EXAMPLE 4

Manufacture 4 of the present invention disease and pest control agent for crops and plants containing dissolved microbubbles consisting of oxygen and ozone

The solution is prepared using the same method as the disease and pest control agent of the present invention given in practical example 2 described above, however the oxygen ozone gas is input at the speed of 21 l/min and the water is input at the speed of 700 l/min into mixer pump then moved to the bubble dissolving apparatus and circulated for 10 minutes to produce a colloid state solution that contains microbubbles with a diameter of 25.0 μm consisting of ozone (O₃) 7.5 volume % and oxygen (O₂) 92.7 volume %.

The ozone concentration level is measured using the system in type of ozone monitor (type EG/EL-550Evala Co), and a solution of a disease and pest control agent for crops of the present invention which has an ozone concentration level of 30 mg/l containing microubbles consisting of oxygen and ozone dissolved in water in colloid state.

### COMPARATIVE EXAMPLE 1

Manufacture of ozone water with dissolved ozone

By the common ordinary method of using the air disperser into water and pressure pump, ozone is dissolved in water for 10 minutes to produce ozone water.

The ozone concentration level is measured using the system in type of ozone monitor (type EG/EL-550Evala Co ), and it was found that ozone water with the ozone concentration level of 0.02 mg/l is produced.

### COMPARATIVE EXAMPLE 2

Comparative manufacture 1 of a solution containing dissolved microbubbles consisting of oxygen and ozone in the colloid state

The solution is prepared using the same method as the disease and pest control agent of the present invention given in practical example 1 described above, however the oxygen ozone gas is input at the speed of 0.1 l/min and the water is input at the speed of 300 l/min into mixer pump then circulated in the bubble dissolving apparatus for 10 minutes to produce a colloid state solution that contains microbubbles with a diameter of 0.3 μm consisting of ozone (O₃) 2.3 volume % and oxygen (O₂) 97.7 volume %.

As a result, a solution in the colloid state with an ozone concentration level of 0.5 mg/l is produced in comparison.

### COMPARATIVE EXAMPLE 3

Comparative manufacture 3 of a solution containing dissolved microbubbles consisting of oxygen and ozone in the colloid state

The solution is prepared using the same method as the disease and pest control agent of the present invention given in practical example 2 described above, however the oxygen ozone gas is input at the speed of 25 l/min and the water is input at the speed of 300 l/min into mixer pump then circulated in the bubble dissolving apparatus for 10 minutes to produce a colloid state solution that contains microbubbles with a diameter of 20.0 μm consisting of ozone (O₃) 7.5 volume % and oxygen (O₂) 92.5 volume %.

As a result, a solution in the colloid state with an ozone concentration level of 35 mg/l is produced in comparison.

### EXPERIMENT EXAMPLE 1

Experiment measuring ozone-concentration level

A disease and pest control agent is prepared according to the method described in the Practical example 2 of the present invention, however, the oxygen ozone gas and water are input at the same time for 10 minutes and the ozone concentration level is measured every 2 minutes.

Ozone water is prepared in accordance with the method described in the Comparative example 1, and ozone is input into water for 10 minutes and the ozone concentration level is measured every 2 minutes.

The result is shown in Table 1 below.

TABLE 1
The result of ozone concentration level measurement

| | 0 min. | 2 min. | | 4 min. | | 6 min. | | 8 min. | | 10 min. |
|---|---|---|---|---|---|---|---|---|---|---|
| practice 2 | 0 mg/l | 2 | mg/l | 4 | mg/l | 6 | mg/l | 8 | mg/l | 1.0 mg/l |
| compare 1 | 0 mg/l | 0.004 | mg/l | 0.008 | mg/l | 0.012 | mg/l | 0.016 | mg/l | 0.02 mg/l |

As shown by the result in the above Table 1, disease and pest control agent of the present invention described in the Practical example 2 contains a vastly higher concentration level of ozone than the ordinary ozone water.

### EXPERIMENTAL EXAMPLE 2

Treatment effect of the disease and pest control agent according to the ozone concentration level.

The disease and pest control agent is prepared in accordance with the Practical examples 1 to 4 of the present invention.

The solution containing microbubbles of oxygen and ozone dissolved in water in the colloid state is prepared described in the Comparative example 2 and Comparative example 3.

An experiment is conducted on the effect of differentiating the spraying time for each of the solution prepared as described above on vegetables and fruit as shown in the tables 2 and 3 below.

For vegetables, Chinese cabbage, radish, chilli, garlic, lettuce, iceberg lettuce, spinach, shallots, Korean leek, sesame and wild sesame were the used in this experiment, and after sowing the vegetables, they were sprayed overall at the rate of 0.3 m³/h for 10 minutes at the pressure of 20 kgf.

At this time, the ozone concentration level of the solution is maintained by continuously supplying the same amount of solution with the same concentration level as the amount that is sprayed into the bubble dissolving apparatus while spraying the crops.

The effect of spraying the vegetables with the disease and pest control agent of the present invention is observed 3 days after spraying and is listed in Table 2 below.

TABLE 2
The result of treatment of vegetables according
to the ozone concentration level 1

| classification | ozone concentration(mg/l) | note |
|---|---|---|
| Practical example 1 | 1 | excellent |
| Practical example 2 | 10 | excellent |
| Practical example 3 | 20 | excellent |
| Practical example 4 | 30 | drying leaves |
| Comparative example 2 | 0.5 | no effect |
| Comparative example 3 | 35 | drying leaves |

As shown in the above Table 2, it can be seen that if the vegetables are sprayed with the disease and pest control agent from the Practical example 1 through to Practical example 3 of the present invention, the result was very good.

However, it was possible to find out that if the vegetables were sprayed with the disease and pest control agent from the Practical example 4 of the present invention with an ozone concentration level of 0.30 mg/l microorganism preventative agent, the leaves became dessicated.

Also, when the colloid solution with an ozone concentration level of 0.5 mg/l from the Comparative example 2 is sprayed, there was no effect at all, and it was possible to find out that if the colloid solution with an ozone concentration level of 35 mg/l from the comparative example 3 is sprayed, the leaves became dessicated.

Therefore, it could be confirmed that when spraying on vegetables with the disease and pest control agent of the present invention, it is the most advisable to use a solution with the ozone concentration level of 1˜20 mg/l.

Also, with regard to fruit, apples, pear, mandarine, chestnut, dates, peaches, Japanese apricots and plums were subjected to an experiment spraying them once every week from before any leaves or flowers came out until they were harvested on the front and back of the leaves and the branches and the stems at the rate of 0.3 m³/h for 10 seconds.

At this time, the ozone concentration level of the solution is maintained by continuously supplying into the bubble dissolving apparatus the same amount of solution with the same concentration level as the amount that is sprayed.

The result of spraying the fruit with the disease and pest control agent of the present invention is observed and recorded in Table 3.

TABLE 3
The result of treatment of fruit according
to the ozone concentration level

| classification | ozone concentration (mg/l) | note |
|---|---|---|
| Practical example 1 | 1 | excellent |
| Practical example 2 | 10 | excellent |
| Practical example 3 | 20 | excellent |
| Practical example 4 | 30 | excellent |
| Comparative example 2 | 0.5 | no effect |
| Comparative example 3 | 35 | drying leaves |

As shown in the above Table 3, it can be seen that if the fruits are sprayed with the disease and pest control agent from the Practical example 1 through to Practical example 4 of the present invention, the result was very good.

However, it was possible to find out that if the fruits were sprayed with the disease and pest control agent from the Comparative example 2 of the present invention with an ozone concentration level of 0.5 mg/l there was no effect, and if the solution with an ozone concentration oevel of 35 mg/l from Comparative example 3 is sprayed, it could be observed that the leaves became dessicated.

Therefore, it could be confirmed that when spraying fruits with the disease and pest control agent of the present invention, it is the most advisable to use a solution with the ozone concentration level of 1˜30 mg/l.

### EXPERIMENTAL EXAMPLE 3

Experiment 1 for the Germicidal activity of the disease and pest control agent of the present invention

The disease and pest control agent of the present invention from Practical examples 1 to 4 are prepared.

The ordinary ozone water from Comparative example 2 is prepared.

Sewage/Dirty water is prepared and the above 5 types of solution is sprayed on the sewage for 4 minutes, and after 5 hours whether or not colon bacillus could be detected as well as the common bacteria numbers are investigated and listed in Table 4 below.

TABLE 4
Experimental result of Germicidal Activity

| | | normal bacteria |
|---|---|---|
| classification | E. coli | (no./ml) |
| Comparstive example 1(O3 0.02 mg/l) | detection | 98 |
| Practical example 1 (O3 0.05 mg/l) | no detection | 40 |
| Practical example 2 (O3 0.10 mg/l) | no detection | 25 |
| Practical example 3 (O3 0.15 mg/l) | no detection | 15 |
| Practical example 4 (O3 0.25 mg/l | no detection | 3 |

As shown in the result of Table 4 above, in the sewage treated with the ordinary ozone water, there was colon bacillus and also common bacteria number of 98/ml, however it was possible to confirm that in the sewage sprayed with the disease and pest control agent from the Practical example 1 to 4 of the present invention, no colon bacillus was detected and the common bacteria number was also very small.

Not used

### EXPERIMENTAL EXAMPLE 4

Experiment 2 for the Germicidal activity of the disease and pest control agent of the present invention

The disease and pest control agent of the present invention from Practical examples 1 to 4 are prepared.

The ordinary ozone water from Comparative example 1 is prepared.

The crops are injected with each bacteria/virus, then treated with the 5 types of solutions that are prepared, and the result are measured 3 days later and analysed and shown in the Table 5 below.

TABLE 5
Experimental result of Germicidal Activity of the disease
and pest control agent of the present experiment.

| | Comparative | Practical | Practical | Practical | Practical |
|---|---|---|---|---|---|
| classification | example 1 | example 1 | Ex. 2 | example. 3 | example. 4 |
| rice blight | 15 | 68 | 70 | 73 | 89 |
| dryness of rice leaves | 8 | 59 | 60 | 65 | 85 |
| gray mold disease | 10 | 65 | 68 | 70 | 78 |
| wilt disease | 8 | 65 | 70 | 70 | 80 |
| curcurbit wilt | 10 | 67 | 73 | 75 | 95 |
| Barley'powdery disease | 12 | 65 | 70 | 72 | 85 |
| mosaic disease | 10 | 58 | 67 | 68 | 80 |
| a dot disease by bacteria | 17 | 60 | 68 | 70 | 82 |

As shown in the above Table 5. it can be seen that the disease and pest control agent from the Practical example 1 to Practical example 4 of the present invention has a superior germicidal effect on each bacteria/virus.

However, it could be confirmed that treatment with ordinary ozone water from the Comparative example 1, there was an insignificant effect.

### EXPERIMENTAL EXAMPLE 5

Analytical experiment for the pesticidal activity of the disease and pest control agent of the present invention

The disease and pest control agent of the present invention from Practical examples 1 to 4 are prepared.

The ordinary ozone water from Comparative example 1 is prepared.

The pesticidal activity is analysed by preparing the larvae of each pest and treated with the 5 types of solution and the pesticidal rate is measured after 3 days.

The result of the analysis is shown in Table 6 below.

TABLE 6
Experimental result of pesticidal activity of the disease
and pest control agent of the present experiment.

| | comparative | practical | practical | practical | practical |
|---|---|---|---|---|---|
| classification | example 1 | example 1 | example 2 | example 3 | example 4 |
| Rice insect' | 10 | 60 | 72 | 80 | 90 |
| leafhopper | | | | | |
| diamondback moth | 15 | 75 | 75 | 80 | 95 |
| two-spotted spider | 15 | 65 | 78 | 82 | 92 |
| mite | | | | | |
| tobacco castrate | 15 | 72 | 75 | 80 | 95 |
| worm | | | | | |
| a duster worm | 10 | 63 | 73 | 85 | 95 |
| cave fly | 13 | 65 | 75 | 85 | 90 |

The numbers which indicates the preventative effect by preventative percentage.

(100: 100% preventative rate, 0: no effect)

As shown in the above Table 6, it could be shown that treatment with the ordinary ozone water from Comparative example 1 had an insignificant effect, however, the disease and pest control agent from the Practical example 1 to Practical example 4 of the present invention has a superior pesticidal effect.

### EXPERIMENTAL EXAMPLE 6

Experiment to annihilate rose aphids with the disease and pest control agent of the present invention

The disease and pest control agent of the present invention from Practical examples 2 is prepared. disease and pest control agent of the present invention at the rate of 0.3 m³/h for 10 seconds, then observed 4 days later.

The result, as can be seen in FIG. 4, it could confirm that the aphids were totally extinguished by the disease and pest control agent of the present invention.

### EXPERIMENTAL EXAMPLE 7

Experiment for the spray effect on plums with the disease and pest control agent of the present invention

The disease and pest control agent of the present invention from Practical examples 3 is prepared.

Plums are sprayed thoroughly before their leaves come out at 1 week interval until the fruits come into bearing with the disease and pest control agent of the present invention at the rate of 0.3 m³/h for 10 seconds.

The result, as can be seen in FIG. 5, could confirm that the untreated plums had dessicated leaves or were curled up and had almost no fruit, but plums treated with the disease and pest control agent of the present invention had lots of leaves and many fruits.

### Effect of the Invention

The present invention produces disease and pest control agent for plants and crops that contains microbubbles consisting of highly concentrated oxygen and ozone dissolved in water as colloid which is environmentally friendly and highly effective as pesticidal and germicidal agent.

Also, the present invention provide a method to treat crops with a solution, which contains microbubbles consisting of oxygen and ozone dissolved in water in colloid state, that maintains its initial concentration level at production.

1-4. (canceled)

5. A disease and pest control agent for plants and crops wherein said agent contains 0.3-40 μm pore size microbubbles consisting of oxygen and ozone, dissolved in water as colloids and said ozone (O₃) is present in said microbubbles at 1.0-10.0 volume % and said oxygen (O₂) is present in said microbubbles at 99.0-90.0 volume %, the concentration of ozone in this solution being 1-30 mg/l.

6. A method for disease and pest control for crops and plants which comprises applying the agent of claim 5 thereto.

7. A method for disease and pest control for food crops, flowers, fruits, herbs and fruit trees which comprises applying the agent of claim 5 thereto.

8. A method for disease and pest control in vegetables which comprises applying the agent thereto of claim 5 at 1-20 mg/l concentration of ozone in solution, to said vegetables.

9. A method manufacturing disease and pest control agents for crops and plants which comprises employing oxygen separation equipment to separate pure oxygen (99.0-99.99% O₂) from the atmosphere and subjecting said oxygen to an ozonizer to produce a gas consisting essentially of ozone (O₃) at 1.0-10.0 volume % and oxygen (O₂) at 99.0-90.0 volume %, employing a 4.5 KW mixer pump to input and mix together the above oxygen and ozone gas at the speed of 0.5-21 l/min and water at the speed of 300-700 l/min and to move the mixed solution from the mixer pump to bubble dissolving equipment, then rotating the mixed solution for 10 minutes, resulting in 0.3-40 μm diameter microbubbles dissolved in water in the colloidal state.

10. A method of spraying crops and plants with a disease and pest control agent which comprises applying an agent containing dissolved microbubbles consisting of oxygen and ozone at 0.3-3 m³/h within one minute, and at the same time of spraying, controlling the input flow speed of oxygen, ozone gas and water into the mixer pump, said process further consisting of maintaining the same level of ozone concentration by continuously supplying the same amount of solution, as the amount of solution used, through the mixer pump, into bubble dissolving equipment at 0.3-3 m³/h, and then spraying the disease and pest control agent containing dissolved microbubbles containing oxygen and ozone on said crops and plants.
